(19) United States
(12) Patent Application Publication
(10) Pub. No.: US 2020/0043427 A1
(43) Pub. Date: Feb. 6, 2020

(54) BACKLIGHT ADJUSTING METHOD AND BACKLIGHT ADJUSTING DEVICE

(71) Applicant: Beijing Xiaomi Mobile Software Co., Ltd., Beijing (CN)

(72) Inventors: Guilin ZHONG, Beijing (CN); Guosheng LI, Beijing (CN); Haining HUANG, Beijing (CN)

(73) Assignee: Beijing Xiaomi Mobile Software Co., Ltd., Beijing (CN)

(21) Appl. No.: 16/526,742

(22) Filed: Jul. 30, 2019

(30) Foreign Application Priority Data
Aug. 2, 2018 (CN) 201810871526.5

(51) Int. Cl. G09G 3/36

(52) U.S. Cl. CPC G09G 3/36; G09G 2320/0626; G09G 2320/041; G09G 2360/144

(57) ABSTRACT

Aspects of the disclosure provide methods for adjusting backlight of devices and devices with adjustable backlight. In one example, a method for adjusting backlight of a device includes obtaining an ambient illuminance and adjusting a screen backlight brightness value of the device to be greater than a preset maximum brightness value when the obtained ambient illuminance is greater than an illuminance threshold. The method further includes detecting a temperature value of the device through a first temperature sensor installed in the device and adjusting the screen backlight brightness value of the device to be lower than or equal to the preset maximum brightness value when the temperature value of the device detected by the first temperature sensor is greater than a temperature threshold.

### CROSS REFERENCE TO RELATED APPLICATION

This application claims priority to Chinese Patent Application No. 201810871526.5, entitled “BACKLIGHT ADJUSTING METHOD AND BACKLIGHT ADJUSTING DEVICE” filed on Aug. 2, 2018. The entire disclosure of the prior application is hereby incorporated by reference in its entirety.

### TECHNICAL FIELD

The present disclosure relates to a field of electronic technologies, and more particularly to a backlight adjusting method and a backlight adjusting device.

### BACKGROUND

A terminal device such as a mobile phone usually emits light through a light array under a screen, and the light emitted passes through a light guide plate to obtain uniform backlight. For example, the light array may be a LED (Light-Emitting Diode) array. A maximum brightness of the backlight has positive correlation with the number of lights in the backlight array and a maximum brightness of each light. Brightness of each light has positive correlation with a current of supplying to each light. The maximum brightness of each light is determined by a maximum current of supplying to each light. Since limited by a structure, for a screen of a specific size, the number of the lights in the light array may be fixed. In addition, since a screen material cannot resist a high temperature, the current of supplying to the light cannot be too high, otherwise an area of the light array will be overheat, resulting in damaging the screen. Therefore, the maximum current of the light is usually limited to a certain scope. Under a strong-light environment (such as an outdoor sunny environment), especially when the sun shines directly on the screen, in order to adapt to the strong-light environment, pupils of human eyes contract, resulting in a decrease in the amount of light into the pupils. Under this circumstance, the screen looks dark, and it is difficult for the user to see content on the screen clearly.

### SUMMARY

Aspects of the disclosure provide methods for adjusting backlight of devices and devices with adjustable backlight. For example, a method for adjusting backlight of a device includes obtaining an ambient illuminance and adjusting a screen backlight brightness value of the device to be greater than a preset maximum brightness value when the obtained ambient illuminance is greater than an illuminance threshold. The method further includes detecting a temperature value of the device through a first temperature sensor installed in the device and adjusting the screen backlight brightness value of the device to be lower than or equal to the preset maximum brightness value when the temperature value of the device detected by the first temperature sensor is greater than a temperature threshold.

In one embodiment, the method further includes adjusting a current for the backlight of the device to a current threshold and the screen backlight brightness value of the device to the preset maximum brightness value when the obtained ambient illuminance reaches the illuminance threshold.

In one embodiment, the method further includes adjusting a current for the backlight of the device to be greater than a current threshold to adjust the screen backlight brightness value of the device to be greater than the preset maximum brightness value when the obtained ambient illuminance is greater than the illuminance threshold.

In one embodiment, the method further includes adjusting the screen backlight brightness value of the device to a first preset value when the obtained ambient illuminance is greater than the illuminance threshold, the first preset value being greater than the preset maximum brightness value.

In one embodiment, the method further includes adjusting the screen backlight brightness value of the device to a value corresponding to a proportional relationship between ambient illuminances and screen backlight brightness values, where the screen backlight brightness values positively correlate with the ambient illuminances.

In one embodiment, the method further includes initiating the first temperature sensor to detect the temperature value of the device when the screen backlight brightness value of the device is greater than the preset maximum brightness value. The method further includes reducing a current for the backlight of the device to adjust the screen backlight brightness value of the device to be lower than or equal to the preset maximum brightness value when the temperature value of the device detected by the first temperature sensor is greater than the temperature threshold.

In one embodiment, the method further includes initiating the first temperature sensor to detect the temperature value of the device when a current for the backlight of the device is greater than a current threshold. The method further includes reducing the current for the backlight of the device to adjust the screen backlight brightness value of the device to be lower than or equal to the preset maximum brightness value when the temperature value of the device detected by the first temperature sensor is greater than the temperature threshold.

In one embodiment, the method further includes adjusting the screen backlight brightness value of the device to the preset maximum brightness value when the obtained ambient illuminance is greater than the illuminance threshold and when the temperature value of the device detected by the first temperature sensor is greater than the temperature threshold.

According to one aspect of the disclosure, there is provided a device with adjustable backlight. For example, the device includes a backlight array having a plurality of lights, a first temperature sensor that is arranged near the backlight array, and a processing circuitry configured to adjust a backlight brightness value of the backlight array according to an ambient illuminance and a temperature value of the backlight array detected through the first temperature sensor.

In one embodiment, the processing circuitry is further configured to adjust a current for each of the plurality of the lights of the backlight array to be greater than a current threshold to adjust the backlight brightness value of the backlight array to be greater than a preset maximum brightness value when the ambient illuminance is greater than an illuminance threshold.

In one embodiment, the processing circuitry is further configured to adjust the backlight brightness value of the backlight array to a first preset value when the ambient illuminance is greater than an illuminance threshold, the first preset value being greater than a preset maximum brightness value.

In one embodiment, the processing circuitry is further configured to adjust the backlight brightness value of the backlight array to a value corresponding to a proportional relationship between ambient illuminances and screen backlight brightness values, where the screen backlight brightness values positively correlate with the ambient illuminances.

In one embodiment, the processing circuitry is further configured to initiate the first temperature sensor to detect the temperature value of the backlight array when the backlight brightness value of the backlight array is greater than a preset maximum brightness value. The processing circuitry is further configured to reduce a current for each of the plurality of the lights of the backlight array to adjust the backlight brightness value of the backlight array to be lower than or equal to the preset maximum brightness value when the temperature value of the backlight array detected by the first temperature sensor is greater than a temperature threshold.

In one embodiment, the processing circuitry is further configured to initiate the first temperature sensor to detect the temperature value of the backlight array when a current for each of the plurality of the lights of the backlight array is greater than a current threshold. The processing circuitry is further configured to reduce the current for the each of the plurality of the lights of the backlight array to adjust the backlight brightness value of the backlight array to be lower than or equal to a preset maximum brightness value when the temperature value of the backlight array detected by the first temperature sensor is greater than a temperature threshold.

In one embodiment, the processing circuitry is further configured to adjust the backlight brightness value of the backlight array to a preset maximum brightness value when the ambient illuminance is greater than an illuminance threshold and when the temperature value of the backlight array detected by the first temperature sensor is greater than a temperature threshold.

According to one aspect of the disclosure, there is provided a non-transitory computer-readable storage medium storing instructions which when executed by at least one processor cause the at least one processor to perform adjusting a backlight brightness value of a backlight array according to an ambient illuminance and a temperature value of the backlight array detected through a first temperature sensor that is arranged near the backlight array.

### BRIEF DESCRIPTION OF THE DRAWINGS

The accompanying drawings herein are incorporated into the specification and constitute part of the specification of the present disclosure, which illustrate embodiments of the present disclosure, and are configured to explain principle of the present disclosure together with the specification.

FIG. 1 is a flow chart illustrating a backlight adjusting method according to an embodiment of the present disclosure.

FIG. 2 is a flow chart illustrating a backlight adjusting method according to an embodiment of the present disclosure.

FIG. 3 is a flow chart illustrating a backlight adjusting method according to another embodiment of the present disclosure.

FIG. 4 is a flow chart illustrating a backlight adjusting method according to another embodiment of the present disclosure.

FIG. 5 is a block diagram illustrating a backlight adjusting device according to an embodiment of the present disclosure.

FIG. 6 is a block diagram illustrating a device 800 for adjusting backlight according to an embodiment of the present disclosure.

### DETAILED DESCRIPTION

Illustration will be made in detail here to exemplary embodiments. Examples of embodiments are illustrated in the accompanying drawings. When description relates to the accompanying drawings, the same numbers in different accompanying drawings represent the same or similar elements, unless otherwise specified, and the implementations described below in the exemplary embodiments do not represent all implementations corresponding to the present disclosure. On the contrary, they are merely examples of devices and methods described in the accompanying claims and consistent with aspects of the present disclosure.

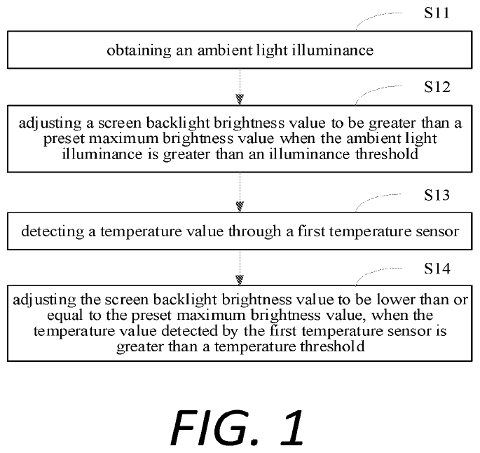

FIG. 1 is a flow chart illustrating a backlight adjusting method according to an embodiment of the present disclosure. The method may be applicable to a terminal device such as a mobile phone, a table computer or a smart wristwatch. As illustrated in FIG. 1, the method includes actions in blocks S11 to S14.

In block S11, an ambient light illuminance is obtained.

In embodiments of the present disclosure, the ambient light illuminance may be obtained by an ambient light sensor.

In block S12, a screen backlight brightness value is adjusted to be greater than a preset maximum brightness value when the ambient light illuminance is greater than an illuminance threshold.

In embodiments of the present disclosure, the screen backlight brightness value may be adjusted to be the preset maximum brightness value when the ambient light illuminance equals to the illuminance threshold. For example, the illuminance threshold is M Lux, a current threshold is X mA, and when the ambient light illuminance equals to M Lux, a backlight current may be adjusted to X mA, to adjust the backlight light brightness value to be the preset maximum brightness value. When the ambient light illuminance is greater than the illuminance threshold, a limitation of the preset maximum brightness value may be broken, to adjust the screen backlight brightness value to be greater than the preset maximum brightness value.

The screen in embodiments of the present disclosure may be a LCD (Liquid Crystal Display).

In a possible implementation, when the ambient light illuminance is greater than the illuminance threshold, the screen backlight brightness value is adjusted to the preset maximum brightness value by the following actions. When the ambient light illuminance is greater than the illuminance threshold, the backlight current is controlled to be greater than the current threshold, to adjust the screen backlight brightness value to be greater than the preset maximum brightness value. For example, the illuminance threshold is M Lux, the current threshold is X mA, and when the ambient light illuminance is N Lux (N Lux is greater than M Lux), the backlight current is controlled to be greater than X mA, to adjust the screen backlight brightness value to be greater than the preset maximum brightness value. In the implementation, when the ambient light illuminance is greater than the illuminance threshold, the boost mechanism may be employed, to enable the backlight current to break the limitation of the current threshold, control the backlight current to be greater than the current threshold, and further to enable to increase the screen backlight brightness value, such that the screen backlight brightness value is greater than the preset maximum brightness value, the limitation of the preset maximum brightness value is broken, and it may help the user to see the screen clearly under a strong-light environment.

In block S13, a temperature value is detected through a first temperature sensor.

In a possible implementation, the temperature value is detected through the first temperature sensor by the following actions. The temperature value is detected through the first temperature sensor when the screen backlight brightness value is greater than the preset maximum brightness value. In the implementation, when the screen backlight brightness value is greater than the preset maximum brightness value, the first temperature sensor is started to detect the temperature value, and then when the temperature value detected by the first temperature sensor is greater than the temperature threshold, the backlight current is decreased timely to reduce the screen backlight brightness value, to avoid to damage the screen due to too high temperature at an area of the backlight array.

In another possible implementation, the temperature value is detected through the first temperature sensor by the following actions. The temperature value is detected through the first temperature sensor when the backlight current is greater than the current threshold. In the implementation, when the backlight current is greater than the current threshold, the first temperature sensor is started to detect the temperature value, and then when the backlight current is greater than the current threshold, the backlight current is decreased timely to reduce the screen backlight brightness value, to avoid to damage the screen due to the too high temperature at the area of the backlight array.

In a possible implementation, the first temperature sensor is provided near the backlight array. In the implementation, the first temperature sensor is provided near the backlight array, such that the temperature value of the area of the backlight array is detected by the first temperature sensor. The backlight array may include one or more rows of backlights.

It is noted that, the term “first” in the first temperature sensor provided in embodiments of the present disclosure is for convenience of expression and reference, and it does not mean that there is one corresponding first temperature sensor in the detailed implementation of the present disclosure. Terms “first” in the first preset value, “second” in the second preset value and the like disclosed below are similar with this.

In block S14, the screen backlight brightness value is adjusted to be lower than or equal to the preset maximum brightness value when the temperature value detected by the first temperature sensor is greater than a temperature threshold.

In a possible implementation, the screen backlight brightness value is adjusted to be lower than or equal to the preset maximum brightness value when the temperature value detected by the first temperature sensor is greater than the temperature threshold by the following actions. The screen backlight brightness value is adjusted to a second preset value when the temperature value detected by the first temperature sensor is greater than the temperature threshold, in which, the second preset value is lower than the preset maximum brightness. The implementation adjusts the screen backlight brightness value to the second preset value when the temperature value detected by the first temperature sensor is greater than the temperature threshold, such that the problem of the area of the backlight array is reduced, and it may avoid damaging the screen due to that the too high temperature of the backlight array.

With embodiments of the present disclosure, by obtaining the ambient light illuminance; adjusting the screen backlight brightness value to be greater than the preset maximum brightness value, when the ambient light illuminance is greater than the illuminance threshold; detecting the temperature value through the first temperature sensor; and adjusting the screen backlight brightness value to be lower than or equal to the preset maximum brightness value, when the temperature value detected by the first temperature sensor is greater than the temperature threshold, it may help the user to see the content on the screen clearly under the strong-light environment, and avoid damaging the screen due to the overheating temperature. Under the strong-light environment such as the outdoor environment, the user usually views a terminal device in a short time period. Therefore, the screen backlight brightness value needs to be increased in the short time period, and the problem that the screen is not viewed clearly under the strong light may be improved.

In a possible implementation, the screen backlight brightness value is adjusted to be greater than the preset maximum brightness value when the ambient light illuminance is greater than the illuminance threshold by the following actions. The screen backlight brightness value is adjusted to a first preset value when the ambient light illuminance is greater than the illuminance threshold, in which, the first preset value is greater than the preset maximum brightness value. For example, the illuminance threshold is M Lux, the current threshold is X mA, and the backlight current is adjusted to Y mA (Y mA is greater than X mA) when the ambient light illuminance is greater than M Lux, such that the screen backlight brightness value is adjusted to the first preset value. In the implementation, regardless of how much the ambient light illuminance is, as long as the ambient light illuminance is greater than the illuminance threshold, the screen backlight brightness value is adjusted to the first preset value. That is, in the implementation, the screen backlight brightness value is adjusted to a fixed value when the ambient light illuminance is greater than the illuminance threshold.

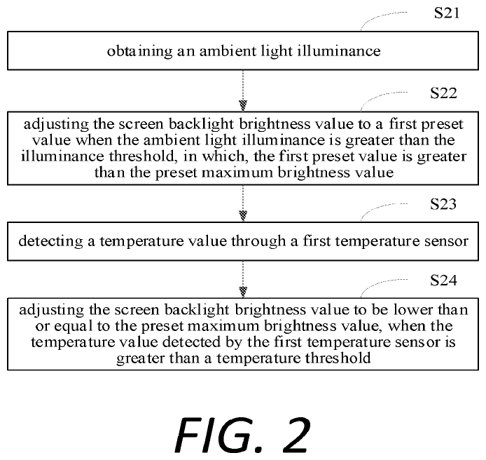

FIG. 2 is a flow chart illustrating a backlight adjusting method according to an embodiment of the present disclosure. As illustrated in FIG. 2, the method includes actions in following blocks S21 to S24.

In block S21, an ambient light illuminance is obtained.

For block S21, reference is made to the description of block S11 according to FIG. 1.

In block S22, a screen backlight brightness value is adjusted to a first preset value when the ambient light illuminance is greater than a illuminance threshold, in which, the first preset value is greater than the preset maximum brightness value.

For block S22, reference is made to the description of the implementation illustrated in FIG. 1.

In block S23, a temperature value is detected through a first temperature sensor.

For block S23, reference is made to the description of block S13 according to FIG. 1.

In block S24, the screen backlight brightness value is adjusted to be lower than or equal to the preset maximum brightness value when the temperature value detected by the first temperature sensor is greater than a temperature threshold.

For block S24, reference is made to the description of block S14 according to FIG. 1.

In another possible implementation, the screen backlight brightness value is adjusted to be greater than the preset maximum brightness value when the ambient light illuminance is greater than the illuminance threshold by the following actions. When the ambient light illuminance is greater than the illuminance threshold, the screen backlight brightness value is adjusted to a value corresponding to the ambient light illuminance according to a corresponding relationship between ambient light illuminances and screen backlight brightness values, in which, when the ambient light illuminance is greater than the illuminance threshold, the screen backlight brightness value corresponding to the ambient light illuminance is greater than the preset maximum brightness value, and the screen backlight brightness value has positive correlation to the ambient light illuminance. In the implementation, the screen backlight lightness increases with the increasing of the ambient light illuminance.

As an embodiment of the implementation, when the ambient light illuminance value is greater than the illuminance threshold, the screen backlight brightness maximum value corresponding to the ambient light illuminance is a third preset value, in which, the third preset value is greater than the preset maximum brightness value. For example, the illuminance threshold is M, the preset maximum brightness value is K, and the third preset value is K′. When M<x<M′,

$$y = \frac{{K}^{′} - K}{{M}^{′} - M} x ,$$

and when x≥M′, y=K′, in which, x represents the ambient light illuminance, Y represents the screen backlight brightness value, M′ represents a fourth preset value, and the fourth preset value is greater than the illuminance threshold.

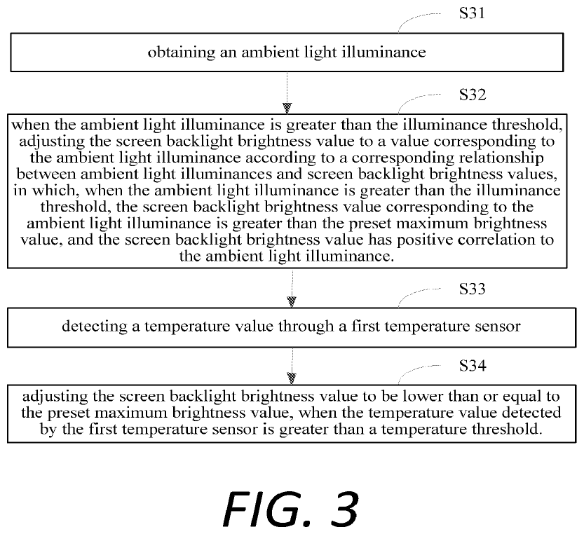

FIG. 3 is a flow chart illustrating a backlight adjusting method according to another embodiment of the present disclosure. As illustrated in FIG. 3, the method includes actions in blocks S31 and S34.

In block S31, an ambient light illuminance is obtained.

For block S31, reference is made to the description of block S11 according to FIG. 1.

In block S32, when the ambient light illuminance is greater than the illuminance threshold, the screen backlight brightness value is adjusted to a value corresponding to the ambient light illuminance according to a corresponding relationship between ambient light illuminances and screen backlight brightness values, in which, when the ambient light illuminance is greater than the illuminance threshold, the screen backlight brightness value corresponding to the ambient light illuminance is greater than the preset maximum brightness value, and the screen backlight brightness value has positive correlation to the ambient light illuminance.

For block S32, reference is made to the description of the implementation illustrated in FIG. 1.

In block S33, a temperature value is detected through a first temperature sensor.

For block S33, reference is made to the description of block S13 according to FIG. 1.

In block S34, the screen backlight brightness value is adjusted to be lower than or equal to the preset maximum brightness value when the temperature value detected by the first temperature sensor is greater than a temperature threshold.

For block S34, reference is made to the description of block S14 according to FIG. 1.

In a possible implementation, the screen backlight brightness value is adjusted to be lower than or equal to the preset maximum brightness value when the temperature value detected by the first temperature sensor is greater than the temperature threshold by the following. The screen backlight brightness value is adjusted to the preset maximum brightness value in response to that the ambient light illuminance is greater than the illuminance threshold when the temperature value detected by the first temperature sensor is greater than the temperature threshold. In the implementation, when the temperature value detected by the first temperature sensor is greater than the temperature threshold, the screen backlight brightness value is adjusted to the preset maximum brightness value in response to that the ambient light illuminance is greater than the illuminance threshold, such that the problem of the area of the backlight array is reduced, and it may avoid damaging the screen due to that the area of the backlight array overheats.

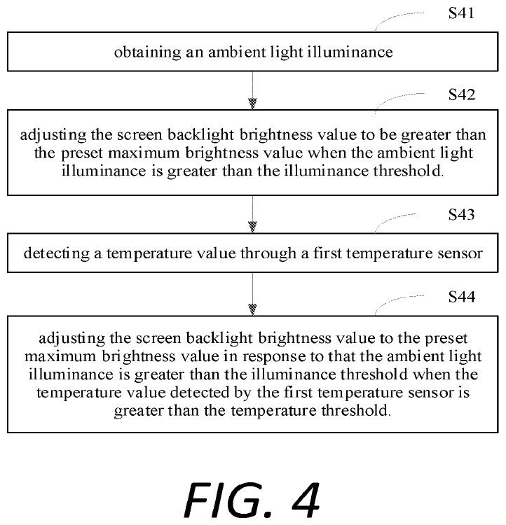

FIG. 4 is a flow chart illustrating a backlight adjusting method according to another embodiment of the present disclosure. As illustrated in FIG. 4, the method includes actions in following blocks S41 to S44.

In block S41, an ambient light illuminance is obtained.

For block S41, reference is made to the description of block S11 according to FIG. 1.

In block S42, a screen backlight brightness value is adjusted to be greater than a preset maximum brightness value when the ambient light illuminance is greater than a illuminance threshold.

For block S42, reference is made to the description of block S12 according to FIG. 1.

In block S43, a temperature value is detected through a first temperature sensor.

For block S43, reference is made to the description of block S13 according to FIG. 1.

In block S44, the screen backlight brightness value is adjusted to the preset maximum brightness value in response to that the ambient light illuminance is greater than the illuminance threshold when the temperature value detected by the first temperature sensor is greater than the temperature threshold.

For block S44, reference is made to the description of implementation illustrated in FIG. 1.

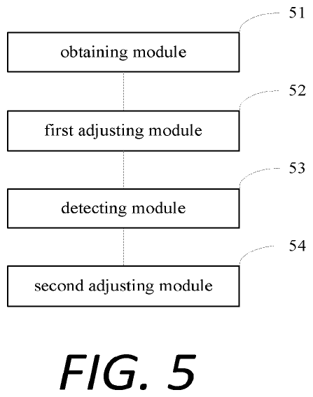

FIG. 5 is a block diagram illustrating a backlight adjusting device according to an embodiment of the present disclosure. As illustrated in FIG. 5, the device includes an obtaining module 51, a first adjusting module 52, a detecting module 53, and a second adjusting module 54.

The obtaining module 51 is configured to obtain an ambient light illuminance.

The first adjusting module 52 is configured to adjust a screen backlight brightness value to be greater than a preset maximum brightness value when the ambient light illuminance is greater than an illuminance threshold.

The detecting module 53 is configured to detect a temperature value through a first temperature sensor.

The second adjusting module 54 is configured to adjust the screen backlight brightness value to be lower than or equal to the preset maximum brightness value when a temperature value detected by the first temperature sensor is greater than a temperature threshold.

In a possible implementation, the first adjusting module 52 is configured to: adjust the screen backlight brightness value to a first preset value when the ambient light illuminance is greater than the illuminance threshold, in which, the first preset value is greater than the preset maximum brightness value.

In a possible implementation, the first adjusting module 52 is configured to: when the ambient light illuminance is greater than the illuminance threshold, adjust the screen backlight brightness value to a value corresponding to the ambient light illuminance according to a corresponding relationship between the ambient light illuminances and screen backlight brightness values, in which, when the ambient light brightness value is greater than the illuminance threshold, the screen backlight brightness value corresponding to the ambient light illuminance is greater than the preset maximum brightness value, and the screen backlight brightness value has positive correlation to the ambient light illuminance.

In a possible implementation, the second adjusting module 54 is configured to: adjust the screen backlight brightness value to the preset maximum brightness value in response to that the ambient light illuminance is greater than the illuminance threshold when the temperature value detected by the first temperature sensor is greater than the temperature threshold.

In a possible implementation, the first adjusting module 52 is configured to: control a backlight current to be greater than a current threshold when the ambient light illuminance is greater than the illuminance threshold, to adjust the screen backlight brightness value to be greater than the preset maximum brightness value.

In a possible implementation, the detecting module 53 is configured to: detect the temperature value through the first temperature sensor when the backlight current is greater than the current threshold.

In a possible implementation, the first temperature sensor is provided near a backlight array.

About the device in embodiments above, the detailed way that respective module executes operations have performed detailed description in embodiments of related method, which is not elaborated and illustrated in detail herein.

With embodiments of the present disclosure, by obtaining the ambient light illuminance; adjusting the screen backlight brightness value to be greater than the preset maximum brightness value when the ambient light illuminance is greater than the illuminance threshold; adjusting the screen backlight brightness value to be lower than or equal to the preset maximum brightness value when the temperature value detected by the first temperature sensor is greater than the temperature threshold, it may help the user to see the content on the screen clearly under the strong-light environment, and avoid damaging the screen due to the too high temperature.

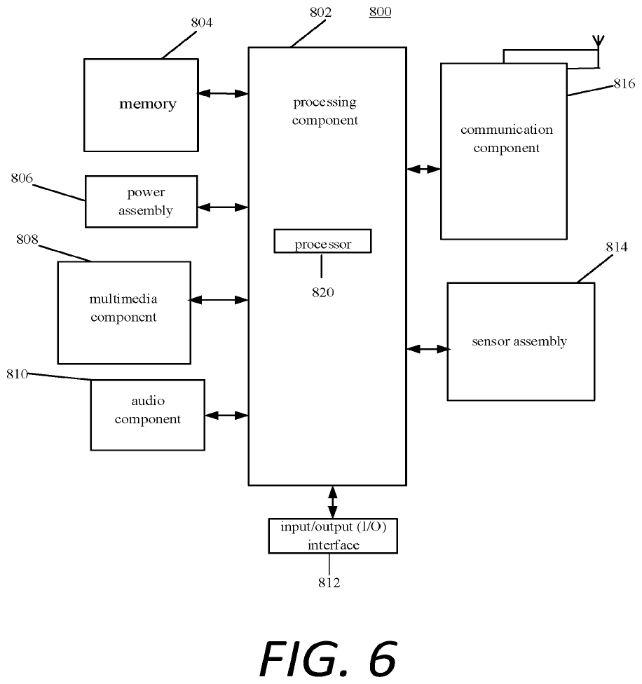

FIG. 6 is a block diagram illustrating a device 800 for adjusting backlight according to an embodiment of the present disclosure. For example, the device 800 may be a mobile phone, a computer, a digital broadcast device, a messaging transceiver device, a game console, a tablet device, a medical device, a fitness device, a personal digital assistant, and the like.

As illustrated in FIG. 6, the device 800 may include one or more components as follows: a processor component 802, a memory 804, an electric power source assembly 806, a multimedia component 808, an audio component 810, an input/output (I/O) interface 812, a sensor assembly 814 and communication operation 816.

The processing component 802 usually controls overall operation of the device 800, such as operations associated with display, telephone calls, data communications, camera operations, and recording operations. The processing component 802 may include one or more processors 820 to execute instructions, to complete all or part of the operations in the above described methods. In addition, the processing component 802 may include one or more modules which facilitate interaction between the processing component 802 and other components. For instance, the processing component 802 may include a multimedia module to facilitate interaction between the multimedia component 808 and the processing component 802.

The memory 804 is configured to store various types of data to support operations at the device 800. Examples of such data include instructions for any applications or methods operated on the device 800, contact data, phonebook data, messages, pictures, videos, etc. The memory 804 may be implemented using any type of volatile or non-volatile storage devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or an optical disk.

The power component 806 provides power to various components of the device 800. The power component 806 may include a power management system, one or more power supplies, and other components related to generation, management, and distribution of power in the device 800.

The multimedia component 808 includes a screen that provides an output interface between the device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may sense a boundary of a touch or swipe action. The touch sensors may also sense a duration and a pressure associated with the touch or swipe action. In some embodiments, the multimedia component 808 includes a front camera and/or a rear camera. When the device 800 is in an operation mode, such as a photographing mode or a video mode, the front camera and/or the rear camera may receive external multimedia data. Each of the front and rear cameras may be a fixed optical lens system or have a focus and optical zoom capability.

The audio component 810 is configured to output and/or input audio signals. For example, the audio component 810 includes a microphone (MIC) configured to receive an external audio signal when the device 800 is in an operating mode, such as a call mode, a recording mode, and a speech recognition mode. The received audio signal may be further stored in the memory 804 or transmitted via the communication component 816. In some embodiments, the audio component 810 further includes a loudspeaker, which is configured to output the audio signals.

The I/O interface 812 provides an interface between the processing component 802 and a peripheral interface module, such as a keyboard, a click wheel, a button and the like. The buttons may include, but are not limited to, a home button, a volume button, a starting button, and a locking button.

The sensor component 814 includes one or more sensors for providing status assessments of various aspects of the device 800. For example, the sensor component 814 may detect an open/closed state of the device 800, relative positioning of the components, such as the display and the keypad of the device 800, a change in position of the device 800 or of a component of the device 800, presence or absence of user contact with that device 800, an orientation or an acceleration/deceleration of the device 800, and a change in temperature of the device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate wired or wireless communication between the device 800 and other devices. The device 800 can access a wireless network based on a communication standard, such as WiFi, 2G, or 3G, or a combination of them. In an exemplary embodiment, the communication component 816 receives a broadcast signal or broadcast related information from an external broadcast management system via a broadcast channel. In an exemplary embodiment, the communication component 816 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the methods described above.

In exemplary embodiments, a non-transitory computer readable storage medium including instructions is also provided, such as the memory 804 including instructions. The instructions can be executed by the processor 820 of the device 800 to perform the methods described above. For example, the non-transitory computer readable storage medium may be a ROM, a random access memory (RAM), a CD-ROM, a magnetic tape, a floppy disk, an optical data storage device, and the like.

It is easy for the skilled in the art to think of another implementation of the present disclosure after considering the disclosure of the specification and practice. The application is intended to cover any variations, uses or adaptations of the present disclosure. This variations, uses or adaptations follow general principles of the present disclosure and include common knowledge or related techniques in the field of the technology not disclosed by the present disclosure. The specification and embodiments are considered to be merely exemplary, and the true scope and spirit of this present disclosure is indicated by the claim below.

It is understood that, the present disclosure is not limited to the accuracy structure described above and illustrated in the accompanying drawings, and may be modified and altered without departing from the scope of the present disclosure. The scope of the present disclosure is limited by the accompanying claims.

It is noted that the various modules, submodules, units, subunits, and components in the present disclosure can be implemented using any suitable technology. For example, a module or a unit can be implemented using processing circuitry. In an example, a module or a unit can be implemented using integrated circuit (IC). In another example, a module or a unit can be implemented as a processor executing software instructions. In another example, interface circuitry is used to implement receiving unit (or module) and/or sending unit (or module).

What is claimed is:

1. A method for adjusting backlight of a device, comprising:
obtaining an ambient illuminance,
adjusting a screen backlight brightness value of the device to be greater than a preset maximum brightness value when the obtained ambient illuminance is greater than an illuminance threshold;
detecting a temperature value of the device through a first temperature sensor installed in the device; and
adjusting the screen backlight brightness value of the device to be lower than or equal to the preset maximum brightness value when the temperature value of the device detected by the first temperature sensor is greater than a termperature threshold.

2. The method of claim 1, wherein the adjusting the screen backlight brightness value of the device to be greater than the preset maximum brightness value when the obtained ambient illuminance is greater than the illuminance threshold, comprises:
adjusting a current for the backlight of the device to a current threshold and the screen backlight brightness value of the device to the preset maximum brightness value when the obtained ambient illuminance reaches the illuminance threshold.

3. The method of claim 1, wherein the adjusting the screen backlight brightness value of the device to be greater than the preset maximum brightness value when the obtained ambient illuminance is greater than the illuminance threshold, comprises:
adjusting a current for the backlight of the device to be greater than a current threshold to adjust the screen backlight brightness value of the device to be greater than the preset maximum brightness value when the obtained ambient illuminance is greater than the illuminance threshold.

4. The method of claim 1, wherein the adjusting the screen backlight brightness value of the device to be greater than the preset maximum brightness value when the obtained ambient illuminance is greater than the illuminance threshold, comprises:
adjusting the screen backlight brightness value of the device to a first preset value when the obtained ambient illuminance is greater than the illuminance threshold, the first preset value being greater than the preset maximum brightness value.

5. The method of claim 1, wherein the adjusting the screen backlight brightness value of the device to be greater than the preset maximum brightness value when the obtained ambient illuminance is greater than the illuminance threshold, comprises:
adjusting the screen backlight brightness value of the device to a value corresponding to a proportional relationship between ambient illuminances and screen backlight brightness values, where the screen backlight brightness values positively correlate with the ambient illuminances.

6. The method of claim 1, wherein the adjusting the screen backlight brightness value of the device to be lower than or equal to the preset maximum brightness value when the temperature value of the device detected by the first temperature sensor is greater than the termperature threshold, further comprises:
initiating the first temperature sensor to detect the temperature value of the device when the screen backlight brightness value of the device is greater than the preset maximum brightness value.

7. The method of claim 6, wherein the adjusting the screen backlight brightness value of the device to be lower than or equal to the preset maximum brightness value when the temperature value of the device detected by the first temperature sensor is greater than the termperature threshold, further comprises:
reducing a current for the backlight of the device to adjust the screen backlight brightness value of the device to be lower than or equal to the preset maximum brightness value when the temperature value of the device detected by the first temperature sensor is greater than the termperature threshold.

8. The method of claim 1, wherein the adjusting the screen backlight brightness value of the device to be lower than or equal to the preset maximum brightness value when the temperature value of the device detected by the first temperature sensor is greater than the termperature threshold, further comprises:
initiating the first temperature sensor to detect the temperature value of the device when a current for the backlight of the device is greater than a current threshold.

9. The method of claim 8, wherein the adjusting the screen backlight brightness value of the device to be lower than or equal to the preset maximum brightness value when the temperature value of the device detected by the first temperature sensor is greater than the termperature threshold, further comprises:
reducing the current for the backlight of the device to adjust the screen backlight brightness value of the device to be lower than or equal to the preset maximum brightness value when the temperature value of the device detected by the first temperature sensor is greater than the termperature threshold.

10. The method of claim 1, wherein the adjusting the screen backlight brightness value of the device to be lower than or equal to the preset maximum brightness value when the temperature value of the device detected by the first temperature sensor is greater than the termperature threshold, further comprises:
adjusting the screen backlight brightness value of the device to the preset maximum brightness value when the obtained ambient illuminance is greater than the illuminance threshold and when the temperature value of the device detected by the first temperature sensor is greater than the temperature threshold.

11. A device, comprising:
a backlight array having a plurality of lights;
a first temperature sensor that is arranged near the backlight array; and
a processing circuitry configured to adjust a backlight brightness value of the backlight array according to an ambient illuminance and a temperature value of the backlight array detected through the first temperature sensor.

12. The device of claim 11, wherein the processing circuitry is configured to adjust a current for each of the plurality of the lights of the backlight array to be greater than a current threshold to adjust the backlight brightness value of the backlight array to be greater than a preset maximum brightness value when the ambient illuminance is greater than an illuminance threshold.

13. The device of claim 11, wherein the processing circuitry is configured to adjust the backlight brightness value of the backlight array to a first preset value when the ambient illuminance is greater than an illuminance threshold, the first preset value being greater than a preset maximum brightness value.

14. The device of claim 11, wherein the processing circuitry is configured to adjust the backlight brightness value of the backlight array to a value corresponding to a proportional relationship between ambient illuminances and screen backlight brightness values, where the screen backlight brightness values positively correlate with the ambient illuminances.

15. The device of claim 11, wherein the processing circuitry is configured to initiate the first temperature sensor to detect the temperature value of the backlight array when the backlight brightness value of the backlight array is greater than a preset maximum brightness value.

16. The device of claim 15, wherein the processing circuitry is configured to reduce a current for each of the plurality of the lights of the backlight array to adjust the backlight brightness value of the backlight array to be lower than or equal to the preset maximum brightness value when the temperature value of the backlight array detected by the first temperature sensor is greater than a termperature threshold.

17. The device of claim 11, wherein the processing circuitry is configured to initiate the first temperature sensor to detect the temperature value of the backlight array when a current for each of the plurality of the lights of the backlight array is greater than a current threshold.

18. The device of claim 17, wherein the processing circuitry is configured to reduce the current for the each of the plurality of the lights of the backlight array to adjust the backlight brightness value of the backlight array to be lower than or equal to a preset maximum brightness value when the temperature value of the backlight array detected by the first temperature sensor is greater than a termperature threshold.

19. The device of claim 11, wherein the processing circuitry is configured to adjust the backlight brightness value of the backlight array to a preset maximum brightness value when the ambient illuminance is greater than an illuminance threshold and when the temperature value of the backlight array detected by the first temperature sensor is greater than a temperature threshold.

20. A non-transitory computer-readable storage medium storing instructions which when executed by at least one processor cause the at least one processor to perform:
adjusting a backlight brightness value of a backlight array according to an ambient illuminance and a temperature value of the backlight array detected through a first temperature sensor that is arranged near the backlight array.
